(19) United States
(12) Patent Application Publication
(10) Pub. No.: US 2006/0044116 A1
(43) Pub. Date: Mar. 2, 2006

(54) Key holder

(76) Inventors: Brian Mehler, Long Beach, CA (US); Andrew Palmer, Palm Desert, CA (US)

Correspondence Address: Gordon E. Gray III;GRAY LAW FIRM, Suite 233, 4401 N. Atlantic Avenue, Long Beach, CA, 90807, US

(21) Appl. No.: 10/931,645

(22) Filed: Aug. 31, 2004

(51) Int. Cl. G05B 19/00; G06F 17/00; G08B 13/14; G09F 25/00; G09F 9/33; G08B 5/22

(52) U.S. Cl. 340/286.01; 340/568.1; 340/571; 340/825.49; 340/815.45

(57) ABSTRACT

The present invention is an improved key holder. In particular, the present invention is directed to a key holder with a plurality of lights for illuminating and identifying keys or key rings attached to the key holder. A preferred embodiment of the key holder comprises a circular hub containing a battery. Preferably, multiple key rings are mounted around the hub and project radially. Indicator lights of differing colors are mounted on the hub in alignment with a corresponding key ring and connected to the battery. A light is mounted on the edge of the hub, preferably an LED. A switch is mounted at the hub's center and connected to the power source, the light source and the indicator lights. The switch has different activation positions including a first activation position that activates the light source and a second activation position that activates at least one of the indicator lights.

### TECHNICAL FIELD

The present invention is an improved key holder. In particular, the present invention is directed to a key holder with a plurality of lights for illuminating and identifying keys or key rings attached to the key holder.

### BACKGROUND ART

Generally, a key holder has a main body attached to a key ring for holding keys. However, keys on typical key holders are only distinguishable from one another by their shape or insignia inscribed on the keys themselves. This can lead to difficulty in distinguishing various keys or key rings, particularly when the user is in a darkened environment, e.g. when trying to find the proper key to unlock a front door of the user's home at night.

Therefore, a key holder that can distinguish individual keys or key rings for identification and use is desired, particularly in darkened environments.

### SUMMARY OF THE INVENTION

The present invention is an improved key holder. In particular, the present invention is directed to a key holder with a plurality of lights for illuminating and identifying keys or key rings attached to the key holder. A preferred embodiment of the key holder comprises a circular hub containing a battery. Preferably, multiple key rings are mounted around the hub and project radially. Indicator lights of differing colors are mounted on the hub in alignment with a corresponding key ring and connected to the battery. A light is mounted on the edge of the hub, preferably an LED. A switch is mounted at the hub's center and connected to the power source, the light source and the indicator lights. The switch has different activation positions including a first activation position that activates the light source and a second activation position that activates at least one of the indicator lights.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a top view of a preferred embodiment of the invention;

FIG. 2 is a bottom view of a preferred embodiment of the invention;

FIG. 2a is a front view of a preferred embodiment of a key ring;

FIG. 3 is a circuit diagram of the preferred embodiments depicted in FIGS. 1 and 2;

FIG. 4 is a top view of another preferred embodiment of the invention;

FIG. 4a is a side view of a preferred embodiment of the indicator light assembly;

FIG. 5 is a circuit diagram of the preferred embodiment depicted in FIG. 4;

FIG. 6 is a top view of another preferred embodiment of the invention; and,

FIG. 7 is a circuit diagram of the preferred embodiment depicted in FIG. 6.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved key holder.

Referring now to FIG. 1, a top view of a preferred embodiment of the invention 10 is shown. In the embodiment shown in FIG. 1, a disk-shaped hub 20 contains a power source 22 such as a battery. Alternately, the hub can have a variety of shapes, polygonal or otherwise, such as, inter alia, a square, an oval, and a pentagon. The hub 20 comprises top and bottom surfaces and an edge. The hub 20 is preferably made of die cast zinc alloy. However, alternate materials can be used such as, inter alia, ABS plastic. The power source 22 is electrically connected to a plurality of indicator lights 25 mounted circumferentially around the top surface of the hub 20. Five (5) indicator lights 25 are shown mounted on the hub 20 in FIG. 1. Preferably, the indicator lights 25 are light emitting diodes (LEDs) mounted on a printed circuit board 50 contained within the hub 20. As shown in FIG. 1, each indicator light 25 corresponds to a key ring 30 projecting radially around the hub 20. Preferably, each indicator light 25 has a different color to assist in distinguishing between each key ring 30. Additionally, a symbol can be placed next to or over the indicator light, (e.g. a house symbol, car symbol, etc.), in order to further indicate the key associated with the indicator light 25. If the symbol is placed over the light, it is preferably translucent so light can shine through the symbol. Alternately, the symbol can be black or another dark color so as to appear in silhouette in the indicator light 25.

A light source 40 is mounted on the edge of the hub 20. Preferably, the light source is a 3 mm round type blue LED lamp with a reverse voltage of 5V, a maximum power dissipation of 80 mW, and a 30-degree viewing angle. The light source 40 is intended to be used as a flashlight. The light source 40 is preferably connected to a switch 24 located at the hub's center. The switch 24 preferably has a number of activation positions. For example, a first activation position could illuminate the light source 40 and a second activation position could illuminate one or more indicator lights 25 for key identification purposes. Alternately, the switch could activate the indicator lights 25 and the light source 40 simultaneously. The embodiment shown in FIG. 1 has switch comprising a button split in half with a “V-wedge.” A rocker switch is used underneath for engaging either of the two activation positions.

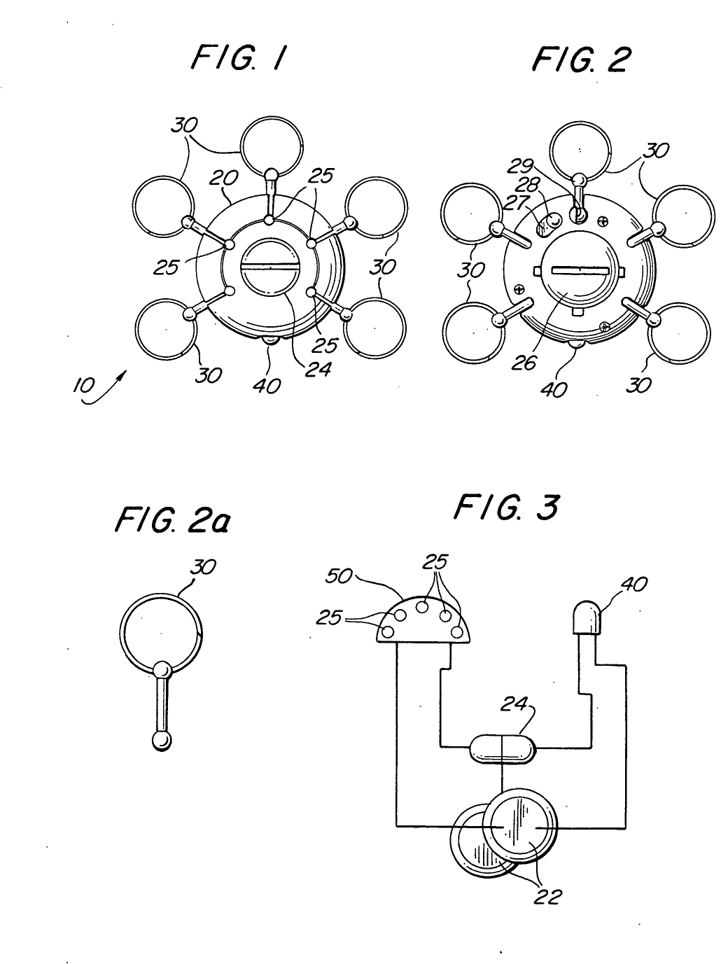

Referring to FIG. 2, a bottom view of a preferred embodiment of the invention is shown. The hub's center preferably has a power source door 26 for access to the power source 22. Moreover, a slide button 28, or valet release switch, is slidable in a slot 27 to move a key ring door 29. When the key ring door 29 is opened, a key ring 30 can be removed from the hub 20. When the key ring door 29 is closed, the key ring 30 is kept on the hub 20. A preferred embodiment of a key ring 30 for use with the hub 20 is shown in FIG. 2a. Only one key ring door 29 is shown in FIG. 2. However, one or more key ring doors 29 can be located on the hub 20. Alternately, the key rings 30 can be permanently radially mounted to the hub 20. The user's contact surface for the switch 24, the slide button 28 and the power source door 26 are preferably made from ABS or HIPS plastic.

Referring to FIG. 3, a circuit diagram of the preferred embodiment of the invention shown in FIGS. 1 and 2 is shown. Preferably, the indicator lights 25 are mounted on a printed circuit board (PCB) mounted in the hub 20. The indicator lights 25 are preferably spot LEDs of differing colors such as red, blue, yellow and/or green. The indicator lights are preferably 2 mm LED lamps with a forward voltage of 1.9V to 3.5V, a reverse voltage of 5V, and a forward current of 20 mA. The power source 22 preferably comprises batteries, e.g. 2 lithium batteries. In the hub 20, the batteries 22 are located on the bottom and connected to the underside of the PCB. The switch 24, preferably a rocker switch, is located on the top side of the PCB 50. All of the indicator lights 25 are preferably mounted to the top side of the PCB 50 and divided by traces.

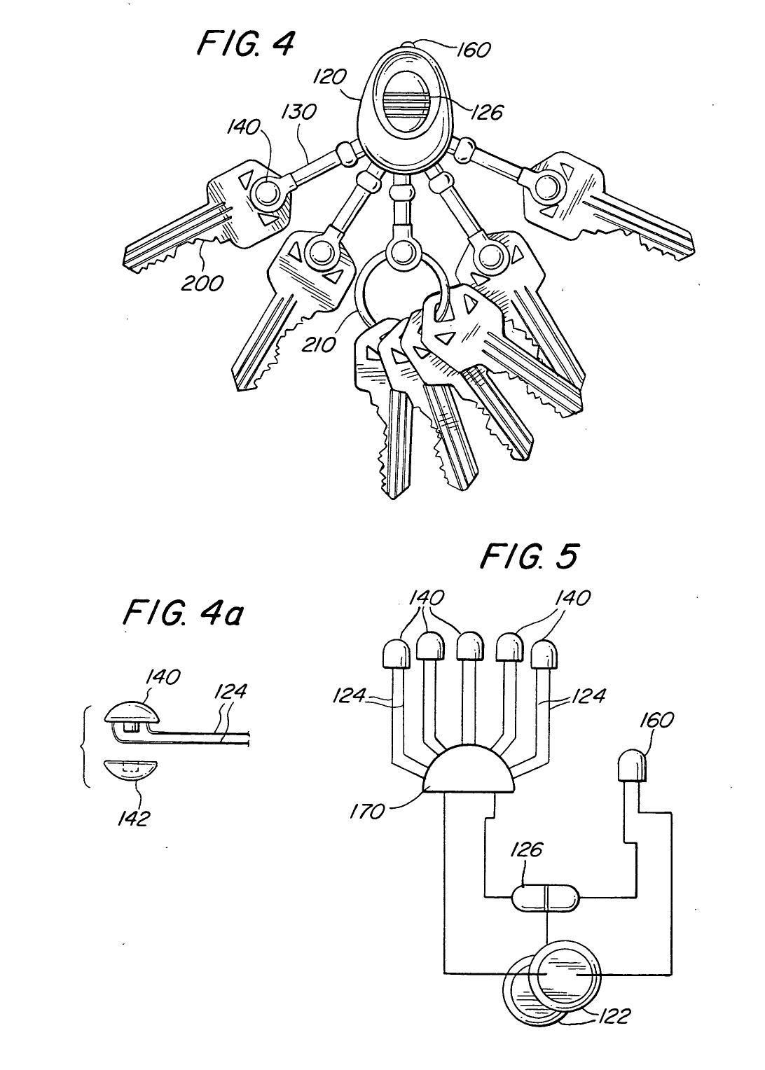

Referring now to FIG. 4, a top view of another preferred embodiment of the invention is shown. In the embodiment shown in FIG. 4, a hub 120 contains a power source 122 such as one or more batteries. The hub 120 comprises top and bottom surfaces and an edge. A plurality of arms 130 extend from the hub 120. Five arms 130 are shown in FIG. 4. Each of the arms 130 is preferably flexible and hollow, e.g. tubular, and fixedly mounted to the hub 120, such as by screw threads on the end of the arm 130. Alternately, the arms 130 can slide in a slot in the hub 120. The power source 122 is electrically connected by a pair of leads 124 strung through an arm 130 to an indicator light 140, mounted on the end of the arm 130. Five (5) indicator lights 140 are shown mounted on arms 130 in FIG. 4. Preferably, the indicator lights 140 are light emitting diodes (LEDs) mounted to a key fixture device having two halves, one half 140 having the LED and a threaded screw and the other half 142 comprising a backing with a threaded receiving socket as shown in FIG. 4a. The indicator light 140 is placed on a key 200 and the other half 142 is screwed onto the threaded screw to hold the key 200 on the arm 130. Alternately, the indicator light LED can be mounted to a snap that snaps onto and holds the key 200 to the arm 130. Alternately, as shown in FIG. 4, the indicator light 140 can be mounted to a key ring 210. As shown in FIG. 4, each arm 130 projects from the hub 20. Preferably, each indicator light 140 has a different color to assist in distinguishing between each key 200 or key ring 210 attached to the invention.

Referring now to FIG. 5, a circuit diagram for the embodiment shown in FIG. 4 is depicted. As shown, five (5) pairs of leads 124, one pair for each indicator light 140, are mounted to a printed circuit board (PCB) 170. Each pair of leads 124 preferably extends through an arm 130. The PCB 170 is connected to a power source 122, e.g. a pair of lithium batteries, and a switch 126. Preferably, a light source 160 is also connected to the switch 126 and the power source 122. The light source 160 is preferably mounted on the edge of the hub 120 so that it can be used as a flashlight. The light source 160 and indicator lights 140 in the embodiment of FIGS. 4 and 5 have specifications like those described above for FIGS. 1-3. In the embodiment shown in FIG. 4, the power source 122 is located below the PCB 170. The switch 126 is located on top of the PCB 170 and visible from the tope side of the hub 120. All indicator lights 140 are connected to the PCB 170 via the leads 124 but are divided by traces.

The switch 126 preferably has a number of activation positions. For example, a first activation position illuminates the light source 160 and a second activation position illuminates one or more indicator lights 140 for key identification purposes. The embodiment shown in FIG. 4 has the switch 126 located at the center of the hub 120.

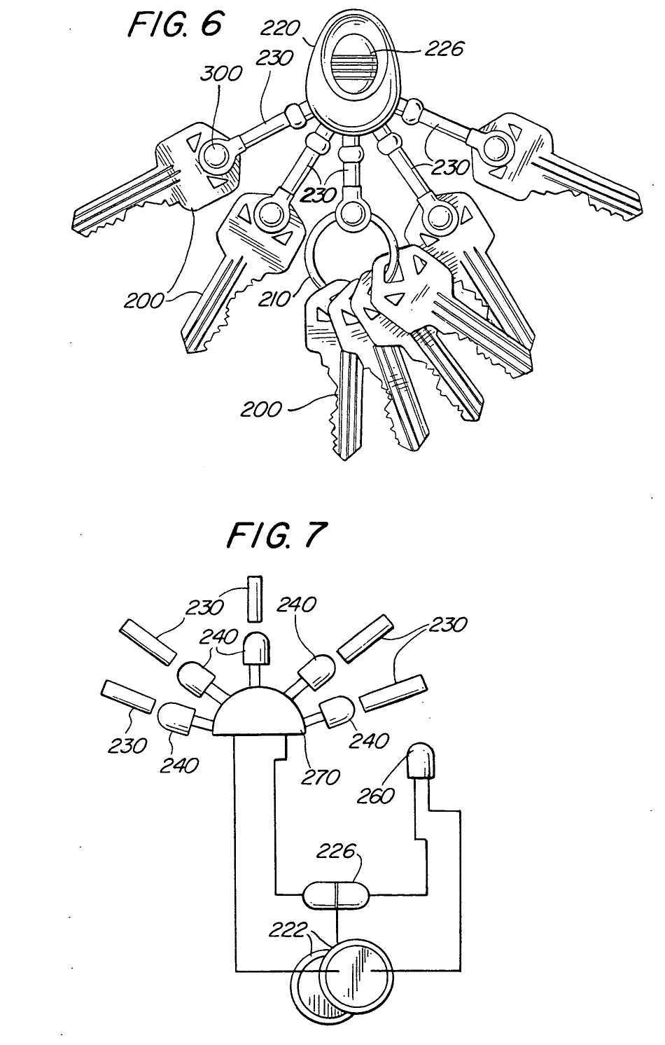

Referring now to FIG. 6, a top view of another preferred embodiment of the invention is shown. In the embodiment shown in FIG. 6, a hub 220 contains a power source 222 such as one or more batteries. The hub 220 comprises top and bottom surfaces and an edge. A plurality of arms 230 extend from the hub 220. Five arms 230 are shown in FIG. 6. Each of the arms 230 is preferably flexible and hollow, e.g. tubular, and fixedly mounted to the hub 220, such as by screw threads on the end of the arm 230. The arms 230 are also preferably translucent, colored polyvinyl chloride (PVC) plastic. This helps the indicator lights 240 provide an even glow from the arms 230 for key identification. Alternately, the arms 230 can be, inter alia, solid translucent material that is clear or colored.

Alternately, the arms 230 can slide in a slot in the hub 220. The power source 222 is electrically connected to a set of indicator lights 240 on a PCB 270 mounted in the hub 220 where the indicator lights 240 are aimed to project light through the arms 230 to illuminate the arms 230. Five (5) indicator lights 240 are shown mounted on the PCB 270 in FIG. 7.

Preferably, the indicator lights 240 are light emitting diodes (LEDs) as described above. The indicator lights 240 can be colored to further indicate the color of the arms 230 or the indicator lights 240 can be white and rely on the color of the arms 230. Alternately, colors generated from the lights 240 and arms 240 can be mixed to create new colors as well. Preferably, each set of indicator light 240 and arm 230 create a different color to assist in distinguishing between each key 200 or key ring 210 attached to the invention.

The keys 200 are preferably mounted to arms 230 or a key ring 210 in the manner described for the embodiment in FIG. 4 above. Instead of an LED mounted to the keys 200, however, a molded plastic colored button 300 can be used instead for day time identification purposes.

Referring now to FIG. 7, a circuit diagram for the embodiment shown in FIG. 6 is depicted. As shown, five (5) indicator lights 240 are mounted to a printed circuit board (PCB) 270. These lights 240 are aim radially from the hub 220 to shine through the respective arms 230. The PCB 270 is connected to a power source 222, e.g. a pair of lithium batteries, and a switch 226. Preferably, a light source 260 is also connected to the switch 226 and the power source 222. The light source 260 is preferably mounted on the edge of the hub 220 so that it can be used as a flashlight. The light source 260 and indicator lights 240 in the embodiment of FIGS. 6 and 7 have specifications like those described above for FIGS. 1-3 and 4-5. In the embodiment shown in FIG. 6, the power source 222 is located below the PCB 270. The switch 226 is located on top of the PCB 270 and visible from the tope side of the hub 220. All indicator lights 240 are connected to the PCB 270 but are divided by traces.

Alternately, a single LED, preferably white, can be mounted within the hub 220 so that its light shines out through each of the different colored arms 230 simultaneously. The different color arms 230 subsequently will glow different colors for key identification purposes. This could reduce the cost and power drain of using multiple indicator lights 240.

Another alternative for each of the embodiments with arms 130, 230, a fiber optic strand can be threaded through the arms to transmit lights from one or more PCB-mounted LEDs. The fiber optic strand can either glow through the length of the arm 130, 230 or can transmit light through the arm 130, 230 to a indicator spot on or near a key attached to the key holder. The indicator spot is preferably colored to indicate which key is attached to the device.

Thus, an improved key holder is described above that can distinguish individual keys or key rings for identification and use, particularly in darkened environments. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A key holder comprising:
a hub containing a power source;
a plurality of key rings attached to the hub;
a plurality of indicator lights mounted on the hub where each indicator light is aligned with a corresponding key ring.

2. The key holder of claim 1 where the hub further comprises a light source having a light emitting diode with a reverse voltage of at least 5 volts.

3. The key holder of claim 1 where each of the plurality of indicator lights is a different colored light emitting diode.

4. The key holder of claim 1 where the hub further comprises a switch that illuminates at least one of the plurality of indicator lights.

5. The key holder of claim 1 where the hub is circular having a circumference and the plurality of key rings are mounted radially around the circumference of the hub.

6. A key holder comprising:
a circular hub having a center and a circumference and containing a power source;
a plurality of key rings mounted around the circumference of the hub and projecting radially;
a plurality of indicator lights mounted on the hub where each indicator light is aligned with a corresponding key ring and connected to the power source;
a light source mounted on the circumference of the hub and connected to the power source; and,
a switch mounted at the center of the hub connected to the power source, the light source and the plurality of indicator lights.

7. The key holder of claim 6 where the hub further comprises a light source having a light emitting diode with a reverse voltage of at least 5 volts.

8. The key holder of claim 6 where each of the plurality of indicator lights is a different colored light emitting diode.

9. The key holder of claim 6 where the switch has a plurality of activation positions and where a first activation position activates the light source and a second activation position activates at least one of the plurality of indicator lights.

10. The key holder of claim 6 where at least one of the plurality of key rings is removable from the hub.

11. A key holder comprising:
a hub having a power source and a switch connected to a plurality of indicator lights;
each indicator light of the plurality of indicator lights corresponding to one key arm of a plurality of key arms;
each key arm having a translucent span and key attachment means; where each indicator light transmits light into the corresponding translucent span.

12. The key holder of claim 11 where each key arm has an indicator mark on the key attachment means.

13. The key holder of claim 11 where the hub further comprises a light source of at least 5 volts.

14. The key holder of claim 11 where at least one key arm is attached to a key ring.

15. The key holder of claim 11 where the plurality of key arms are slidably attached to the hub at a key arm channel.

16. The key holder of claim 11 where the indicator lights are mounted on a printed circuit board contained within the hub and aimed to transmit light into corresponding key arm spans.

17. A key holder comprising:
a hub having a power source and a switch connected to an indicator light mounted within the hub;
a plurality of key arms extend from the hub;
each key arm having a hollow span and a snap for holding a key; where the indicator light transmits light into each of the hollow spans of the plurality of key arms.

18. The key holder of claim 17 where the each key arm of the plurality of key arms is flexible and further comprises a different color for key indication.

19. The key holder of claim 17 further comprising at least one fiber optic fiber connected to the indicator light that passes through at least one of the plurality of key arms and transmits light to an indicator spot on a key snap.

20. A key holder comprising:
a hub having a power source and a switch connected to a plurality of indicator lights, each indicator light having a corresponding pair of leads;
each indicator light of the plurality of indicator lights mounted to one end of one key arm of a plurality of key arms;
each key arm having key attachment means and a hollow and translucent span.

21. The key holder of claim 20 where each key arm is flexible.

22. The key holder of claim 20 where each key attachment means comprises a snap.

23. The key holder of claim 20 where each indicator light comprises a light emitting diode of a different color.
